(19) United States
(12) Patent Application Publication
(10) Pub. No.: US 2005/0134706 A1
(43) Pub. Date: Jun. 23, 2005

(54) Mobile communication terminal equipped with camera and method of controlling the same

(75) Inventors: Jun-Ho Moon, Anyang-Si (KR); Won-Ik Ryu, Seoul (KR); Ki-Hyung Jeong, Seoul (KR); Sung-Il Son, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 11/013,460

(22) Filed: Dec. 17, 2004

(30) Foreign Application Priority Data
Dec. 20, 2003 (KR) 10-2003-0094310

(51) Int. Cl. H04N 9/68

(52) U.S. Cl. 348/236

(57) ABSTRACT

Disclosed are a mobile communication terminal and a method capable of taking a high-quality picture by providing a flash or light function according to ambient luminance when a camera mounted in the mobile communication terminal takes a picture. The mobile communication terminal equipped with a camera includes: a luminance sensor unit for outputting an analog electrical signal proportional to ambient luminance; a control unit for generating a preview light enable signal according to the analog electrical signal; and a preview light for emitting light in a preview mode in response to the preview light enable signal. In addition, a method of controlling a mobile communication terminal equipped with a camera unit and a light unit includes the steps of: enabling a luminance sensor unit to detect ambient luminance according to a camera mode selection command; comparing a light intensity value obtained from a signal outputted from the luminance sensor unit with a pre-programmed threshold value; and controlling the operation of the light unit according to the comparison result.

### BACKGROUND OF THE INVENTION

This application claims the priority of Korean Patent Application No. 2003-94310, filed on Dec. 20, 2003, in the Korean Intellectual Property Office, the disclosure of which is incorporated herein in its entirety by reference.

1. Field of the Invention

The present invention relates to a mobile communication terminal and, more particularly, to a mobile communication terminal equipped with a camera in which a flash is triggered according to ambient luminance and a method of controlling the mobile communication terminal equipped with a camera.

2. Description of Related Art

In general, when a camera module incorporated in a mobile communication terminal is operated, a preview mode is triggered to display a picked-up image, which is projected through a lens system, on a liquid crystal display (LCD). The displayed image is captured when a picture-taking button is pressed. The captured image is compressed and stored in an internal memory of the mobile communication terminal.

A conventional flash, which is equipped into the mobile communication terminal to take a picture in poor lighting areas, is typically triggered by an optical sensor integrated circuit (IC) which detects the intensity of light. That is, the optical sensor detects the light intensity and compares the detected light intensity with a threshold value which is set in a hardware manner. Subsequently, the optical sensor outputs a digital signal indicating a ‘high’ or ‘low’ level to a general-purpose input/output (GPIO) terminal in a mobile station modem (MSM). The MSM determines whether or not to activate the flash in response to the digital signal.

A conventional flash trigger system has the following three drawbacks.

Firstly, there is a problem in that the optical sensor IC for detecting the light intensity is expensive. As a result, the total manufacturing cost for the mobile communication terminal increases significantly.

Secondly, since some of the GPIO terminals, which are provided in the MSM to be used for application operations in the mobile communication terminal, are used to trigger the flash, it may occur that there are no GPIO terminals available for other application operations in the mobile communication terminal. Furthermore, there is a problem in that since a threshold value, which is used in determining whether the light intensity detected by the optical IC is high or low, is set in a hardware manner, the threshold value cannot be readjusted once the mobile communication terminal has been assembled.

### SUMMARY OF THE INVENTION

The present invention provides a mobile communication terminal equipped with a camera and a method capable of taking a high-quality picture by activating a flash according to ambient luminance when the camera takes a picture.

The present invention also provides a mobile communication terminal with a camera and a method capable of easily varying in a software manner a luminance threshold value used in activating the flash.

In accordance with an aspect of the present invention, there is provided a mobile communication terminal with a camera, comprising: a luminance sensor unit for outputting an analog electrical signal proportional to ambient luminance; a control unit for generating a preview light enable signal according to the analog electrical signal; and a preview light for emitting light in a preview mode in response to the preview light enable signal.

The mobile communication terminal equipped with a camera may further comprise a flash for emitting light in response to a flash enable signal when a camera shutter is triggered.

The mobile communication terminal equipped with a camera may further comprise an input unit for allowing a user to set a threshold value arbitrarily.

The control unit may compare a light intensity value obtained from the electrical signal with the arbitrarily set threshold value to determine whether or not to generate the preview light enable signal.

In accordance with another aspect of the present invention, there is provided a mobile communication terminal equipped with a camera, comprising: a luminance sensor unit for outputting an analog electrical signal proportional to ambient luminance; a light unit for emitting light onto an area to be picture-taken by the camera; and a control unit for comparing a light intensity value obtained from the analog electrical signal with a pre-programmed threshold value to control the operation of the light unit.

The control unit may comprise an A/D converter for converting the analog electrical signal inputted from the luminance sensor unit into a digital signal.

The luminance sensor unit may comprise a photodiode which is driven by a camera mode selection signal outputted from the control unit to output the analog electrical signal proportional to the ambient luminance.

The luminance sensor unit may further comprise a transimpedance amplifier for converting a current signal outputted from the photodiode into a voltage signal.

The light unit may comprise a preview light and a flash.

Each of the preview light and the flash may comprise: a switch for operating in response to a lighting control signal from the control unit so that electric power can be supplied; a light emitting device for emitting light by being turned on or off; and a resistor for limiting current flow supplied to the light emitting device via the switch.

The preview light may be turned on in the preview mode when the light intensity value detected through the luminance sensor unit is less than the threshold value, and the flash may be fired when a camera shutter is triggered.

The control unit may comprise an MSM for receiving the analog electrical signal through an HKADC (House Keeping Analog to Digital Converter) terminal to generate the preview light enable signal and outputting the preview light enable signal through a GPIO terminal.

In accordance with another aspect of the present invention, there is provided a method of controlling a mobile communication terminal equipped with a camera unit and a light unit, the method comprising the steps of: enabling a luminance sensor unit to detect ambient luminance according to a camera mode selection command; comparing a light intensity value obtained from a signal outputted from the luminance sensor unit with a pre-programmed threshold value; and controlling the operation of the light unit according to the comparison result.

The step of controlling the operation of the light unit may further comprise the steps of: lowpass-filtering an analog signal representing the light intensity value outputted from the luminance sensor unit; and converting the lowpass-filtered analog signal into a digital signal.

The step of controlling the operation of the light unit may further comprise the step of turning on a preview light provided in the light unit when the light intensity value obtained from the signal outputted from the luminance sensor unit is less than the threshold value.

The step of controlling the operation of the light unit may further comprise the step of firing a flash provided in the light unit when the light intensity value obtained from the signal outputted from the luminance sensor unit is equal to or greater than the threshold value and a picture-taking command is input through an input unit

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing the configuration of a mobile communication terminal in accordance with the present invention;

FIG. 2 is a circuit diagram showing the configuration of a luminance sensor unit shown in FIG. 1;

FIG. 3 is a circuit diagram showing the configuration of a light unit shown in FIG. 1; and

FIG. 4 is a flowchart showing a method of controlling a mobile communication terminal in accordance with the present invention.

### DETAILED DESCRIPTION OF THE INVENTION

Exemplary embodiments in accordance with the present invention will now be described in detail with reference to the accompanying drawings.

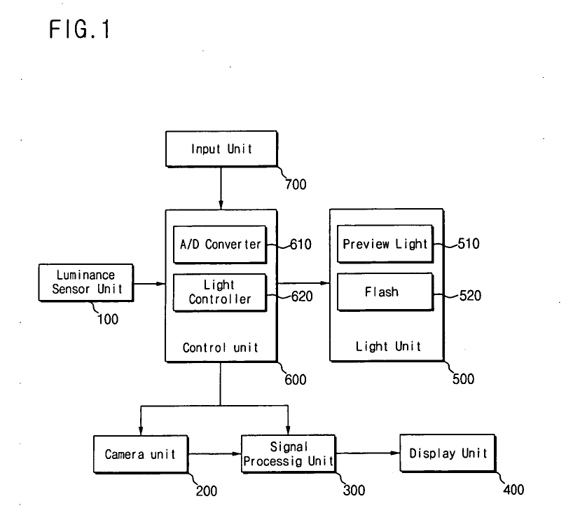

FIG. 1 is a block diagram showing the configuration of a mobile communication terminal in accordance with the present invention. The mobile communication terminal comprises an input unit 700, a display unit 400, a luminance sensor unit 100, a camera unit 200, a signal processing unit 300, a light unit 500 and a control unit 600.

The input unit 700 receives a user command and transfers the user command to the control unit 600 so that the camera unit 200 can take a picture and output the picture in response to the user command. The display unit 400 displays a picked-up image inputted through a lens system under the control of the control unit 600. The input unit 700 and the display unit 400 can employ well-known configurations.

The control unit 600 compares a value indicating light intensity based on an electrical signal, which is output from the luminance sensor unit 100, with a threshold value which is preset by a program. The control unit 600 controls an ON or OFF state of the light unit 500 according to the comparison result. A mobile station modem integrated circuit (MSM IC) is employed as the control unit 600, which comprises a device dedicated for communications, a digital signal processor, and other general-purpose microprocessors.

The luminance sensor unit 100 outputs an electrical signal proportional to ambient luminance as a picture-taking mode, i.e., a camera mode, is set through the input unit 700. The electrical signal is input into a House Keeping Analog to Digital Converter (HKADC) terminal of the MSM, which will be described below.

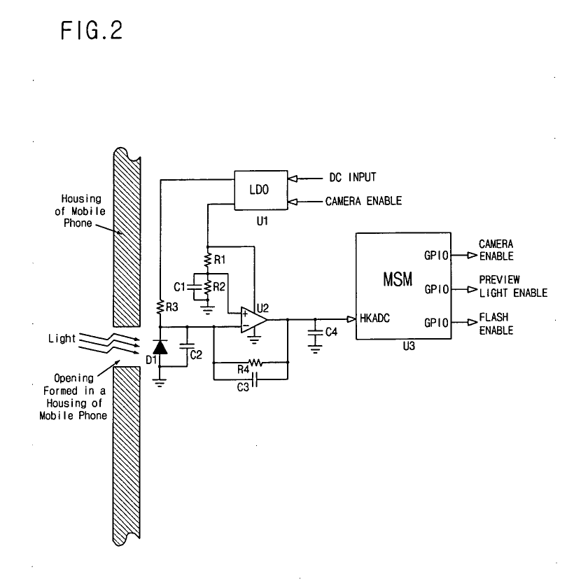

As shown in FIG. 2, the luminance sensor unit 100 comprises: a low dropout (LDO) regulator U1 activated in response to a camera selection signal outputted from the control unit 600; a photodiode D1 which is driven by the LDO regulator U1 and disposed to face a picture-taking area at an opening formed in the mobile communication terminal; and a transimpedance amplifier U2 which is driven by the regulator U1 and converts a current signal outputted from the photodiode D1 into a voltage signal.

In accordance with the present invention, since the photodiode D1 is used for detecting light and the transimpedance amplifier U2 is used for converting a current signal outputted from the photodiode D1 into a voltage signal, the mobile communication terminal can be inexpensively manufactured as compared to the conventional mobile communication terminal in which an expensive optical sensor is used to detect light intensity. In addition, there is an advantage in that the light intensity is accurate since it is obtained from an analog signal rather than a digital signal, such as ‘high’ or ‘low’.

On the other hand, the camera unit 200 converts a picked-up image signal projected through a lens system into an electrical signal. The camera unit 200 comprises: a lens system; an image pickup unit for converting the image signal outputted from the lens system into an analog signal; and a converter for converting the analog signal outputted from the image pickup unit into a digital signal and converting the digital signal into a signal suitable for an input to the signal processing unit 300.

Here, the lens system comprises one or more small-sized lenses. The image pickup unit is typically constituted by a complementary metal oxide semiconductor (CMOS) or a charge-coupled device (CCD) image pickup element. The converter converts a current or voltage signal outputted from the image pickup unit into a digital signal, which is in turn converted into YUV format. The converter may further comprise a codec for compressing a picked-up image into Joint Photographic Experts Group (JPEG) format.

On the other hand, the signal processing unit 300 processes the electrical signal outputted from the camera unit 200 and outputs the processed electrical signal to the display unit 400 or stores the processed electrical signal in its own internal memory. The signal processing unit 300 receives 8-bit YUV-format image data outputted from the camera unit 200 and buffers the received 8-bit YUV-format image data into the internal memory. The signal processing unit 300 may comprise a codec for storing image data in the internal memory and decompressing the stored data. The codec may comprise a JPEG encoder/decoder for compressing a captured image frame into a still image, storing and reading the still image. The signal processing unit 300 may comprise a definition enhancement circuit for improving image quality. Further, the signal processing unit 300 may have a contrast adjustment function and a filtering function for graphic effects.

The signal processing unit 300 outputs the image data in 16-bit RGB format to the display unit 400. In the present embodiment, an image picked up by the camera unit 200 is frame-captured and compressed into the JPEG format in the signal processing unit 300. The compressed image is stored in a flash memory provided in the signal processing unit 300. The signal processing unit 300 decompresses the still image stored in the flash memory and the display unit 400 displays the decompressed image.

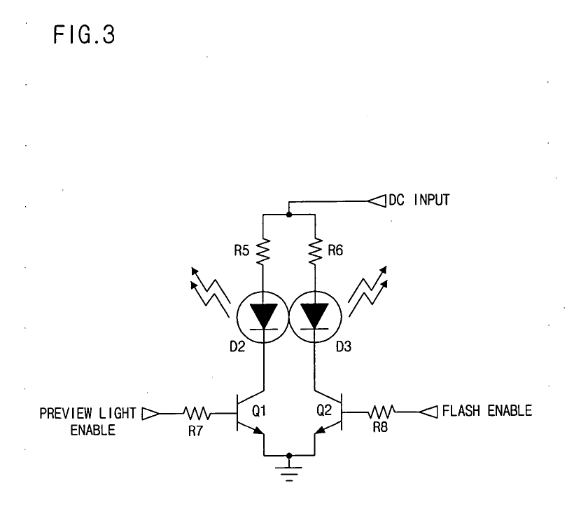

The light unit 500, which illuminates light onto an area to be picture-taken by the camera unit 200, includes at least two lights: a preview light 510 for emitting light according to ambient luminance in a preview mode and a flash 520 for emitting light when a camera shutter is triggered. As shown in FIG. 3, the lights comprise switches Q1 and Q2 for carrying out a switching operation in response to a lighting control signal from the control unit 600, light emitting devices D2 and D3 for emitting light by electric power supplied through the switches Q1 and Q2, and resistors R5 and R6 for limiting a current flow to be supplied to the light emitting devices D2 and D3 through the switches Q1 and Q2.

When a light intensity value inputted from the luminance sensor unit 100 in the preview mode is less than a preset threshold value, the control unit 600 outputs a control signal for turning on the preview light 510. When the camera shutter is triggered, the control unit 600 outputs a control signal for turning on the flash 520.

As described above, the mobile communication terminal in accordance with the present invention automatically activates the preview light 510 according to the ambient luminance so that an object can be clearly recognized. Moreover, the mobile communication terminal activates the flash 520 so that a sufficient amount of light can be supplied through the lens system when the camera shutter is triggered, whereby a high-quality picture can be taken in poor lighting areas.

On the other hand, the control unit 600 comprises an analog-to-digital (A/D) converter 610 for converting an analog signal inputted from the luminance sensor unit 100 into a digital signal; and a light controller 620 for comparing a light intensity value outputted from the A/D converter 610 with a preset threshold value and outputting a lighting control signal to the light unit 500 if the light intensity value is less than the preset threshold value.

In accordance with the present invention, a signal indicating the light intensity value outputted from the luminance sensor unit 100 is input into an HKADC terminal rather than into a GPIO terminal of the MSM. Accordingly, the GPIO terminal can be used for other application operations in the mobile communication terminal.

The control unit 600 operates to lowpass-filter a signal indicating the light intensity value on a software basis, which is inputted to the HKADC terminal from the luminance sensor unit 100, and compares the light intensity value with the preset threshold value. When the light intensity value is less than the preset threshold value, the control unit 600 outputs a lighting control signal to the light unit 500 through the GPIO terminal. Here, the preset threshold value is one acquired through repeated experimentation. Alternatively, a user may directly set the threshold value through a setup menu displayed on the mobile communication terminal.

In accordance with the present invention, since the luminance threshold value, determining the operation of the light unit 500, is set in a software manner, the threshold value can be easily changed after the mobile communication terminal is assembled. Moreover, a threshold value setup function may be added to the setup menu in the mobile communication terminal so that a user can directly set the threshold value.

A method of controlling a flash function in the mobile communication terminal in accordance with the present invention will now be described with reference to FIGS. 2, 3 and 4.

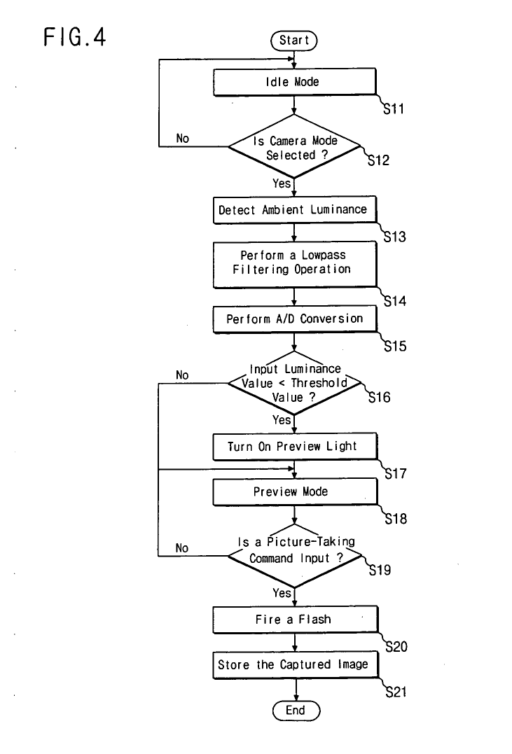

As shown in FIG. 4, the mobile communication terminal is set to be in an idle mode at ordinary times (S11). When a camera mode is selected through the input unit 700 (S12), the mobile communication terminal in the idle mode is switched into a camera mode in response to a control command from the control unit 600.

When the mobile communication terminal is switched into the camera mode, the control unit 600 drives the luminance sensor unit 100 to detect the luminance of an area to be picture-taken (S13). That is, when a camera enable signal is output from a GPIO terminal in the MSM U3 to the LDO regulator U1 in the luminance sensor unit 100, the LDO regulator U1 operates in response to the camera enable signal to activate the photodiode D1 and an operational amplifier (OP-AMP) U2.

The photodiode D1 outputs a current in proportion to light intensity. As shown in FIG. 2, the current outputted from the photodiode D1 is applied to a negative (−) input terminal in the OP-AMP U2. A voltage on the LDO regulator U1 is divided by resistors R1 and R2, and the divided voltage across the resistor R2 is applied, as a reference voltage, to a positive (+) input terminal in the OP-AMP U2. A capacitor C1 connected parallel to the resistor R2 acts to prevent the reference voltage from being affected by noise.

An output signal of the OP-AMP U2 is fed back to the negative input terminal through a resistor R4. The OP-AMP U2 acts as a transimpedance amplifier for outputting a voltage proportional to an inputted current. Here, capacitors C2, C3 and C4 are used for reducing the effects caused by noise.

As described above, the luminance sensor unit 100 converts a signal indicating the light intensity value proportional to an amount of incident light into a voltage signal, which is in turn inputted into the HKADC terminal of the MSM U3.

The voltage signal, which is an analog signal, is subjected to a software-based lowpass filtering operation (S14). The A/D converter 610 in the control unit 600 converts the analog signal representing the light intensity value outputted from the luminance sensor unit 100 into digital data (S15).

The digital data indicating the light intensity value is compared with the threshold value preset by the light controller 620 (S16). If the detected light intensity value is less than the preset threshold value, the MSM U3, the control unit 600, outputs a preview light enable signal through the GPIO terminal to turn on the preview light 510 provided in the light unit 500.

If the detected light intensity value is equal to or greater than the threshold value, the MSM U3 does not output the preview light enable signal since the detected ambient luminance is no less than a currently set luminance level.

As shown in FIG. 3, the preview light enable signal is applied to a base terminal of a transistor Q1 constituting the preview light 510 to turn on the preview light 510 provided in the light unit 500, thereby turning on the transistor Q1 (S17). That is, the electric power is supplied to the light emitting diode D2 of the preview light 510 through the turned-on transistor Q1, so that the light emitting diode D2 emits light. Accordingly, an object can be clearly recognized through the display unit 400 in the preview mode when a picture is taken in poor lighting areas (S18).

When a picture-taking command is input through the input unit 700 in the preview mode (S19), i.e., when a camera shutter is triggered, the light controller 620 outputs a flash enable signal to fire the flash 520. That is, the MSM U3 outputs the flash enable signal through another GPIO terminal. The flash enable signal is input into a base terminal of a transistor Q2, thereby turning on the transistor Q2. Accordingly, the electric power is supplied to the light emitting diode D3 constituting the flash 520 through the turned-on transistor Q2, so that the light emitting diode D3 emits light (S20).

The signal processing unit 300 captures and compresses the taken image, and then stores the compressed image in its own internal memory (S21). Unless an additional picture-taking command or mode switching command is input, the mobile communication terminal remains in preview mode.

In accordance with the present invention, it is possible to provide a mobile communication terminal and a method capable of taking a high-quality picture in poor lighting areas by activating first and second light sources, where the first light source enables a user to clearly recognize an object through an LCD in poor lighting areas when a camera mode is activated, and the second light source transfers a sufficient amount of light through a lens when a camera shutter is triggered.

In addition, it is possible to easily change a threshold value determining whether or not to turn on the light source, since the threshold value is set in a software manner in the present invention.

Further, since the present invention employs a photodiode as an element for detecting light intensity and a transimpedance amplifier as an element for outputting a voltage signal proportional to a current signal outputted from the photodiode, the mobile communication terminal can be manufactured inexpensively as compared to the conventional one employing an optical sensor as an element for detecting the light intensity.

Moreover, the present invention uses an HKADC terminal rather than a GPIO terminal in an MSM in triggering a flash, so that the GPIO terminal can be used for other application operations in the mobile communication terminal.

While the present invention has been described with reference to exemplary embodiments thereof, it will be understood by those skilled in the art that various changes in form and details may be made therein without departing from the scope of the present invention as defined by the following claims.

1. A mobile communication terminal equipped with a camera, comprising:
a luminance sensor unit for outputting an analog electrical signal proportional to ambient luminance;
a control unit for generating a preview light enable signal according to the analog electrical signal; and
a preview light for emitting light in a preview mode in response to the preview light enable signal.

2. The mobile communication terminal of claim 1, further comprising a flash for emitting light in response to a flash enable signal when a camera shutter is triggered.

3. The mobile communication terminal of claim 2, wherein the luminance sensor unit comprises a photodiode for outputting the analog electrical signal proportional to the ambient luminance.

4. The mobile communication terminal of claim 2, further comprising an input unit for allowing a user to set a threshold value arbitrarily.

5. The mobile communication terminal of claim 4, wherein the control unit comprises an A/D (analog-to-digital) converter for converting the analog electrical signal into a digital signal.

6. The mobile communication terminal of claim 5, wherein the control unit compares a light intensity value obtained from the digital signal with the arbitrarily set threshold value to determine whether or not to generate the preview light enable signal.

7. The mobile communication terminal of claim 1, wherein the control unit comprises an MSM (mobile station modem) for receiving the analog electrical signal through an HKADC (House Keeping Analog to Digital Converter) terminal to generate the preview light enable signal and outputting the preview light enable signal through a GPIO (general-purpose input/output) terminal.

8. A mobile communication terminal equipped with a camera, comprising:
a luminance sensor unit for outputting an analog electrical signal proportional to ambient luminance;
a light unit for emitting light onto an area to be picture-taken by the camera; and
a control unit for comparing a light intensity value obtained from the analog electrical signal with a pre-programmed threshold value to control the operation of the light unit.

9. The mobile communication terminal of claim 8, wherein the control unit comprises an A/D converter for converting the analog electrical signal inputted from the luminance sensor unit into a digital signal.

10. The mobile communication terminal of claim 8, wherein the luminance sensor unit comprises a photodiode which is driven by a camera mode selection signal outputted from the control unit to output the analog electrical signal proportional to the ambient luminance.

11. The mobile communication terminal of claim 10, wherein the luminance sensor unit further comprises a transimpedance amplifier for converting a current signal outputted from the photodiode into a voltage signal.

12. The mobile communication terminal of claim 8, wherein the light unit comprises a preview light and a flash.

13. The mobile communication terminal of claim 12, wherein each of the preview light and the flash comprises:
a switch for operating in response to a lighting control signal from the control unit so that electric power can be supplied;
a light emitting device for emitting light by being turned on or off; and
a resistor for limiting current flow supplied to the light emitting device via the switch.

14. The mobile communication terminal of claim 12, wherein the preview light is turned on in the preview mode when the light intensity value detected through the luminance sensor unit is less than the threshold value, and the flash is fired when a camera shutter is triggered.

15. The mobile communication terminal of claim 14, wherein the luminance sensor unit comprises a photodiode which is driven by a camera mode selection signal outputted from the control unit to output the analog electrical signal proportional to the ambient luminance.

16. The mobile communication terminal of claim 15, wherein the luminance sensor unit further comprises a transimpedance amplifier for converting a current signal outputted from the photodiode into a voltage signal.

17. The mobile communication terminal of claim 8, wherein the control unit comprises an MSM for receiving the analog electrical signal through an HKADC terminal to generate the preview light enable signal and outputting the preview light enable signal through a GPIO terminal.

18. A method of controlling a mobile communication terminal equipped with a camera unit and a light unit, the method comprising the steps of:
enabling a luminance sensor unit to detect ambient luminance according to a camera mode selection command;
comparing a light intensity value obtained from a signal outputted from the luminance sensor unit with a pre-programmed threshold value; and
controlling the operation of the light unit according to the comparison result.

19. The method of claim 18, wherein the step of controlling the operation of the light unit further comprises the steps of:
lowpass-filtering an analog signal representing the light intensity value outputted from the luminance sensor unit; and
converting the lowpass-filtered analog signal into a digital signal.

20. The method of claim 18, wherein the step of controlling the operation of the light unit further comprises the step of turning on a preview light provided in the light unit when the light intensity value obtained from the signal outputted from the luminance sensor unit is less than the threshold value.

21. The method of claim 18, wherein the step of controlling the operation of the light unit further comprises the step of firing a flash provided in the light unit when the light intensity value obtained from the signal outputted from the luminance sensor unit is equal to or greater than the threshold value and a picture-taking command is input through an input unit.
